(19) United States
(12) Patent Application Publication
(10) Pub. No.: US 2007/0261204 A1
(43) Pub. Date: Nov. 15, 2007

(54) PIVOTAL DEVICE

(75) Inventors: Sheng-Nan Lu, Shulin City (TW); Chia-Ko Chung, Shulin City (TW)

Correspondence Address: PATENTTM.US, P. O. BOX 82788, PORTLAND, OR, 97282-0788, US

(73) Assignee: SHIN ZU SHING CO., LTD., Shulin City (TW)

(21) Appl. No.: 11/382,669

(22) Filed: May 10, 2006

(51) Int. Cl. E05D 11/08; E05C 17/64

(52) U.S. Cl. 16/340

(57) ABSTRACT

A pivotal device has a shaft that is inserted into a stationary element, a ring, and a coil spring in turn. A fastener is mounted securely on the shaft to position foregoing components. A movable element is mounted securely on an end of the shaft. The fastener is mounted securely between the stationary element and the movable element so that the distance between the stationary element and the movable element is fixed and the present invention is easy to be installed in the laptop.

### BACKGROUND OF THE INVENTION

1. Field of the Invention

The present invention relates to a pivotal device, and more particularly to a pivotal device that is easy to be provided in a device with a cap and a chassis.

2. Description of the Related Art

A conventional pivotal device has a shaft, a stationary element, a movable element, multiple washers and a fastener. The shaft is mounted pivotally in the movable element, the stationary element and the washers in turn. The fastener is mounted around an end of the shaft to fasten foregoing components. The movable element is mounted in a cap of the device and the stationary element is mounted in a chassis of the device so that the cap can be rotated relative to the chassis via the movable element being rotated relative to the stationary element. However, the distance between the movable element and the stationary element is not fixed such that the movable and the stationary element are installed inconveniently.

Therefore, the invention provides a pivotal device to mitigate or obviate the aforementioned problems.

### SUMMARY OF THE INVENTION

The main objective of the present invention is to provide a pivotal device with is easy to be installed in a device with a cap and a chassis.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a pivotal device in accordance with the present invention;

FIG. 2 is an exploded perspective view of the pivotal device in FIG. 1;

FIG. 3 is another exploded perspective view of the pivotal device in FIG. 1;

FIG. 4 is a side view of the pivotal device in FIG. 1; and

FIG. 5 is a perspective view of the pivotal device in FIG. 1 in usage.

### DETAILED DESCRIPTION OF THE PREFERRED EMBODIMENT

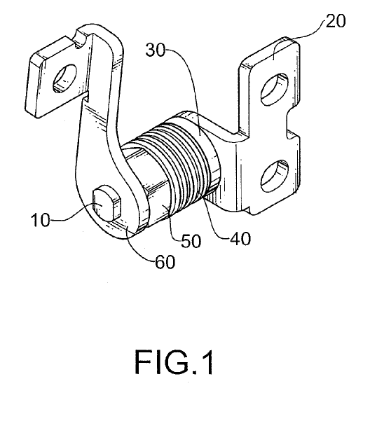

With reference to FIG. 1, a pivotal device has a shaft (10), a stationary element (20), a ring (30), a spring (40), a fastener (50), and a movable element (60).

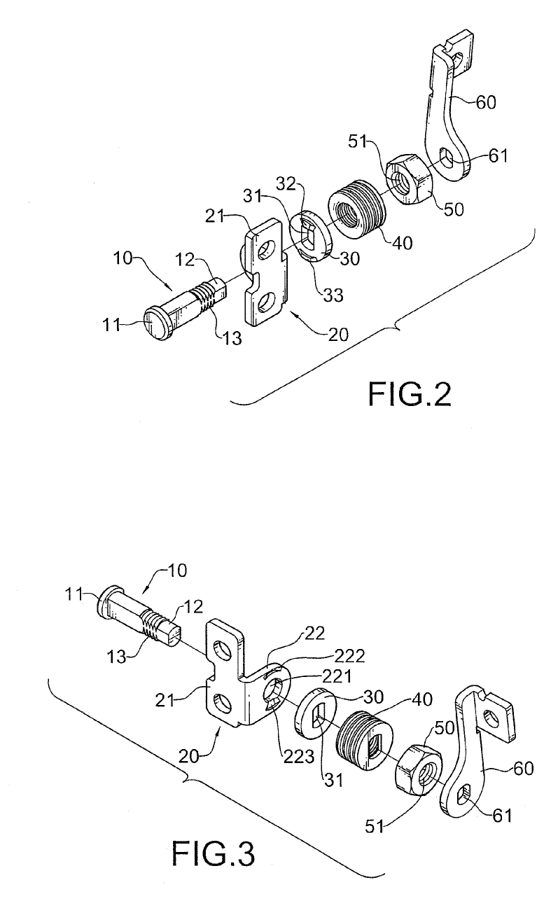

With further reference to FIGS. 2 and 3, the shaft (10) is non-circular in cross section and has a head (11), a bar (12) and a male threaded portion (13). The head (11) is formed in a first end of the shaft (10) and extends out of the shaft (10). The bar (12) is formed in a second end of the shaft (10) and extends out of the shaft (10). The male threaded portion (13) is formed on the shaft (10) and is adjacent to the bar (12).

The L-shaped stationary element (20) has a lug (21) extending out of an end of the stationary element (20) and an ear (22) formed at a side of the stationary element (20) and being perpendicular to the lug (21). The ear (22) has a circular hole (221) defined in the center of the ear (22), and a first channel (222) and a second channel (223) respectively defined in the ear (22). The first channel (222) is defined opposite to the second channel (223) and respectively have two first inclined surfaces.

The ring (30) has a non-circular hole (31) defined in a center of the ring (30) and a first protrusion (32) and a second protrusion (33) formed respectively on a side of the ring (30). The first and the second protrusions (32, 33) respectively have two second inclined surfaces.

The fastener (50) has a female threaded hole (51) defined a center of the fastener (50).

The movable element (60) has a non-circular through hole (61) defined in a lower end of the movable element (60).

In assembly, the stationary element (20) via the circular hole (221), the ring (30) via the non-circular hole (31), the spring (40), the fastener (50) via the female threaded hole (51) and the movable element (60) via the through hole (61) are respectively mounted on the shaft (10) in turn. When the ring (30) rotates relative to the stationary element (20), the first and the second protrusions (32, 33) selectively engage with or disengage from the first and the second channels (222, 223). The male threaded portion (13) screws into the female threaded hole (51) thereby the fastener (50) being fastened with the male threaded portion (13) and the stationary element (20), the ring (30) and the spring (40) can be fastened on the shaft (10) between the head (11) and the fastener (50).

The movable element (60) is mounted around the bar (12) via the through hole (61) being mated with the bar (12).

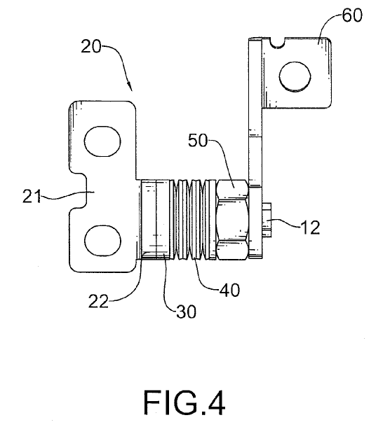

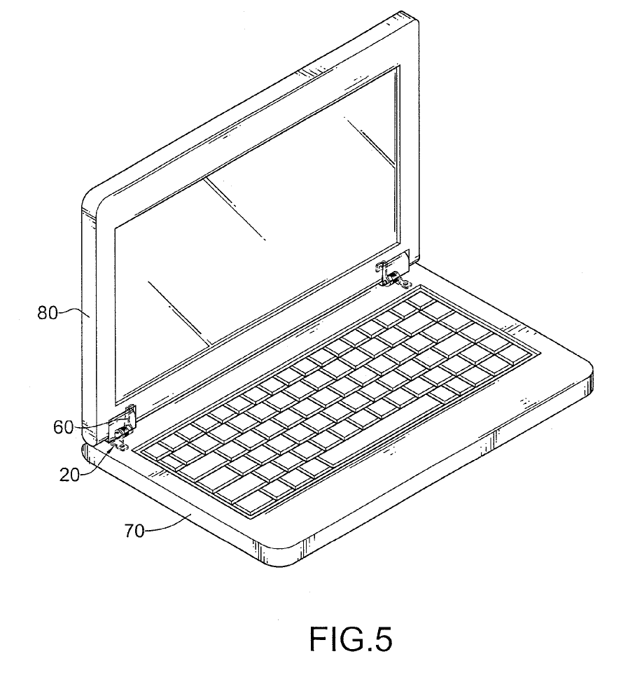

With further reference to FIGS. 4 and 5, the stationary element (20) is mounted in a chassis (70) of a laptop and the movable element (60) is mounted in a cap (80) of the laptop (60). The movable element (60) is mounted securely at a free end of the shaft (12) and the fastener (50) is mounted securely between the stationary element (20) and the movable element (60) so that the distance between the stationary element (20) and the movable element (60) is fixed. Therefore, the present invention is easy to be installed in the laptop (60).

It is to be understood, however, that even though numerous characteristics and advantages of the present invention have been set forth in the foregoing description, together with details of the structure and function of the invention, the disclosure is illustrative only. Changes may be made in details, especially in matters of shape, size, and arrangement of parts within the principles of the invention to the full extent indicated by the broad general meaning of the terms in which the appended claims are expressed.

What is claimed is:

1. A pivotal device comprising:
a shaft having
a head formed in a first end of the shaft,
a bar formed in a second end of the shaft, and
a male threaded portion formed on the shaft and being adjacent to the bar;
an L-shaped stationary element having
a lug,
an ear perpendicularly formed on and extending from the lug and having
a circular hole defined in a center of the ear and mounted around the shaft,
at least one channel defined in the ear and being adjacent to the circular hole of the ear and each one having two first inclined surfaces defined in two sides of the channel;
a ring mounted securely on the shaft and being adjacent to the ear and having
at least one protrusion formed on the ring, corresponding and selectively engaging with the at least one channel and each one having two second inclined surfaces defined in two sides of the protrusion;
a spring mounted around the shaft;
a fastener having
a female threaded hole defined in a center of the fastener wherein the fastener is fastened on the shaft via the female threaded hole screwing onto the male threaded portion; and
a movable element mounted securely on the bar.

2. The pivotal device as claimed in claim 1, wherein the shaft is non-circular in cross section, a non-circular hole is defined in a center of the ring, wherein the ring is mounted securely on the shaft via the non-circular hole, and a non-circular through hole is defined in a lower end of the movable element, wherein the movable element is mounted securely on the bar via the through hole.

3. The pivotal device as claimed in claim 2, wherein the bar is securely mounted to the through hole in the movable element.
